(19) United States
(12) Patent Application Publication
(10) Pub. No.: US 2016/0241147 A1
(43) Pub. Date: Aug. 18, 2016

(54) COMPENSATION FREE MODULATION FOR POWER CONVERTERS

(71) Applicant: ZENTRUM MIKROELEKTRONIK DRESDEN AG, Dresden (DE)

(72) Inventor: Chris YOUNG, Round Rock, TX (US)

(73) Assignee: ZENTRUM MIKROELEKTRONIK DRESDEN AG, Dresden (DE)

(21) Appl. No.: 15/025,947

(22) PCT Filed: Sep. 29, 2014
(86) PCT No.: PCT/EP2014/070814

§ 371 Date: Mar. 30, 2016

Related U.S. Application Data
(60) Provisional application No. 61/884,244, filed on Sep. 30, 2013.

(51) Int. Cl. H02M 3/158; H02M 1/088

(52) U.S. Cl. CPC H02M 3/158; H02M 1/088; H02M 2001/0003

(57) ABSTRACT

A method is provided for controlling a power stage of a power converter configured to generate an output voltage from an input voltage according to a control law controlling a switchable power stage. The method includes generating a pulsed control signal for switching the power stage and translating the pulsed control signal in phase relative to a constant frequency clock signal. The pulse is translated forward to increase charge in a cycle. The pulse is translated backward to decrease charge in a cycle. Thus, this method of charge control does not require compensation.

### FIELD OF THE INVENTION

The present invention relates to a modulation technique for power converters that does not require compensation. The present invention specifically relates to pulse translation modulation for power converters.

### BACKGROUND OF THE INVENTION

Switched DC-DC converters comprise a switchable power stage, wherein an output voltage is generated according to a switching signal and an input voltage. The switching signal is generated in a digital control circuit that adjusts the output voltage to a reference voltage. A buck converter is shown in FIG. 1. The switched power stage 11 comprises a dual switch consisting of a high-side field effect transistor (FET) 12 and a low-side FET 13, an inductor 14 and a capacitor 15. During a charge phase, the high-side FET 12 is turned on and the low-side FET 13 is turned off by the switching signal to charge the capacitor 25. During a discharge phase the high-side FET 12 is turned off and the low-side FET 13 is turned on to match the average inductor current to the load current. The switching signal is generated as pulse width modulation signal with a duty cycle determined by a control law by the controller 16. Pulse modulation typically requires compensation that is implemented by the controller 16.

Specifically, multiple power converters comprise a plurality of power stages or plants. Then, the compensation has to be determined for each plant. This requires a substantial amount of work to determine the optimal compensation. In recent years, controllers that automatically compensate have begun to appear in the market. Another approach is a modulation technique that does not require compensation at all. As a variable frequency technique, sliding mode control can be configured to be compensation free

Furthermore, each plant can be operated either in continuous-conduction-mode (CCM) or in discontinuous conduction mode. (CCM) means that the current in the energy transfer inductor substantially never goes to zero between switching cycles, although it may cross zero current going from positive to negative current. In DCM the current goes to zero and remains at zero during part of the switching cycle. In buck derived converters as shown in FIG. 1 the major effect is that when it changes from CCM to DCM, it goes from one control law to another control law. In boost and buck-boost derived systems there is a right-half-plane zero in CCM which is not present in the DCM. This makes it much more difficult to stabilize these converters with good dynamic response

DCM regulation therefore typically requires compensation that is different from CCM. Thus, transition from discontinuous to continuous conduction mode requires a rapid controlled change in compensation. Hence, a compensation free control method might be advantageous to relieve this problem.

### DISCLOSURE OF THE INVENTION

It is an objective of the present disclosure to provide an efficient compensation free control method for a power stage of a power converter. It is specifically an objective of the present disclosure to provide a control method for a power stage that improves the transition from discontinuous to continuous conduction mode and vice versa.

This objective is achieved with a method for controlling a power stage according to the independent method claim and a power converter according to the independent apparatus claim. Dependent claims relate to further aspects of the present invention.

The present invention relates to method for a power converter configured to generate an output voltage from an input voltage according to a control law controlling a switchable power stage. The method comprises generating a pulsed control signal for switching the power stage and translating a pulse of the pulsed control signal in phase relative to a constant frequency clock signal. The pulse is translated forward to increase charge in a cycle. The pulse is translated backward to decrease charge in a cycle. Thus, this method of charge control does not require compensation.

Generally, the pulsed control signal is a cyclic or periodic signal. A pulse width modulation signal is cyclic pulsed control signal. In contrast to a modulation technique based on compensation that adjusts the duty cycle of the PWM control signal, according to the present invention a pulse of a nominally unaltered pulse width is just translated in time.

The nominal pulse width can be determined by a number of means. One method of determining the nominal pulse width is by way of integral control. Here the nominal pulse width is determined to give a zero integral of the voltage error. This integral process is insensitive to noise and integral value over a large range of values and plant parameters.

One aspect of the present invention relates to an additional charge control. If there is insufficient space within a cycle to translate the pulse forward, the charge in a cycle has to be additionally increased. Alternatively, if there is insufficient space to translate the pulse backward, the charge in a cycle has to be additionally decreased. Insufficient space means a pulse would enter a next cycle or period of the periodic pulsed control signal

The charge may be increased or decrease by varying a pulse width of the pulsed control signal so that a square of the pulse width varies in dependence of a voltage error derived from a difference between a reference voltage and the output voltage. This is a predictive method of charge control as the charge to be delivered in a cycle dependends on the voltage error and the square of the pulse width

The method is specifically advantageous for the discontinuous conduction mode as the requirement of a rapid controlled change in compensation is relieved in that the discontinuous conduction mode does not require compensation

Specifically, the method may comprise varying the pulse width of the pulsed control signal such that a resulting charge Q of a capacitance of the switchable power stage is given by

$$Q = \frac{{V}_{in} - {V}_{out}}{2 L} ( \frac{{V}_{in}}{{V}_{out}} ) {t}_{p}^{2} ,$$

wherein Vᵢₙ is the input voltage, Vₒᵤₜ is the output voltage, L is an inductance of the switchable power stage and tₚ is the pulse width of the pulsed control signal.

When a steady pulse width tₛₛ is determined otherwise, the method may comprise varying the pulse width of the pulse control signal by augmenting the steady state pulse width tₛₛ by an additional on-time t_{d} such that an additional charge Q_{d} of a capacitance of the switchable power stage is given by

$$\begin{matrix}{Q}_{d} = \frac{{V}_{in} - {V}_{out}}{2 L} ( \frac{{V}_{in}}{{V}_{out}} ) {t}_{d} [ 2 {t}_{ss} - {t}_{d} ] \\ \approx \frac{{V}_{in} - {V}_{out}}{2 L} ( \frac{{V}_{in}}{{V}_{out}} ) {t}_{d} {t}_{ss} .\end{matrix}$$

The method may further comprise determining the steady state pulse width tₛₛ prior to generating the pulse control signal.

One aspect of the present invention relates to pulse position restoration. If there is a steady or quasi-steady current change the pulse position may need to be restored.

If there is a steady state shift in current, then each cycle needs an increase or decrease in charge. This will result in a steady state shift in the pulse position. This steady state or even quasi-steady state shift can be detected and the pulse width momentarily increased or decreased as described above to offset the translation. That is, for example, if the pulse has a steady state position that is advanced in time relative to its original position, then the pulse can be increased for a single cycle (or even multiple cycles) as needed to restore the steady state pulse position to its original value.

Therefore, the method may further comprise attempting to detect a steady state or quasi-steady state shift in current and adjusting the pulse width to offset a pulse translation resulting from a steady state or quasi-steady state shift when a steady state or quasi-steady state shift has been detected.

The present invention further relates to a power converter comprising a switched power stage configured to generate an output voltage form an input voltage and being controlled by a control law implemented by a controller. The controller is configured to generate a pulsed control signal for switching the power stage and to translate a pulse the pulsed control signal in phase relative to a constant frequency clock signal. The controller translates the pulse forward to increase charge in a cycle. The controller translates the pulse backward to decrease charge in a cycle.

### BRIEF DESCRIPTION OF THE DRAWINGS

Reference will be made to the accompanying drawings, wherein

FIG. 1 shows a prior art switching buck converter;

FIG. 2 shows a diagram showing an inductor current and pulse width modulation (PWM) switching signal of a switchable power stage operated in a compensation free method of pulse translation charge control;

FIG. 3 shows a diagram showing an inductor current and a pulse width modulation (PWM) switching signal of a switchable power stage operated in DCM; and

FIG. 4 shows a diagram showing an inductor current and a pulse width modulation (PWM) switching signal of a switchable power stage operated in DCM when a steady state duty cycle is determined otherwise.

### DETAILED DESCRIPTION OF THE INVENTION

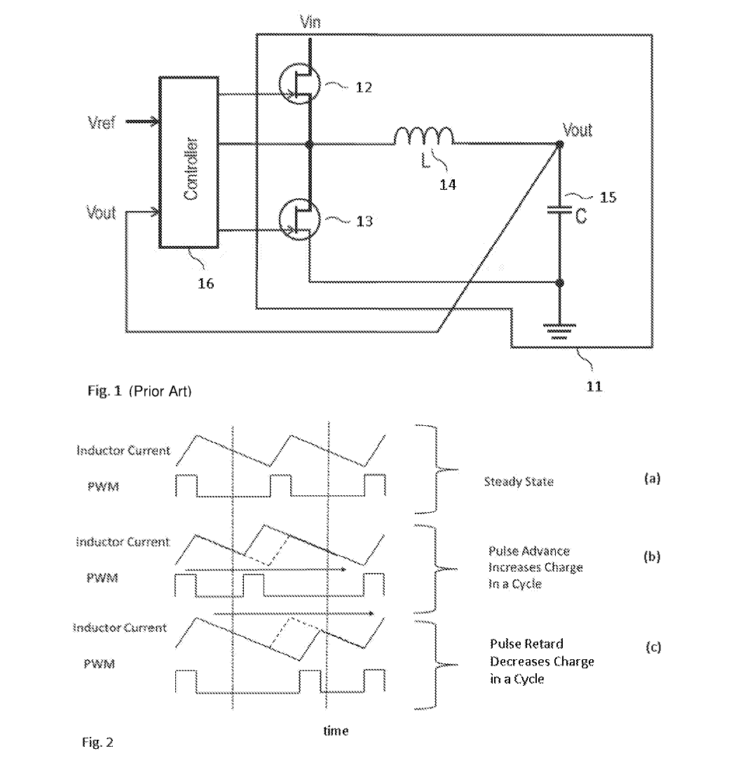

A power converter as shown in FIG. 1 is operated in a compensation free method of charge control. The controller 16 generates a PWM control signal for switching the switchable power stage, wherein the pulsed control signal is forwarded to the high-side FET 12 and the complement of the control signal is forwarded to the low side FET 13. The controller 16 translates a pulse of the pulsed control signal in phase relative to a constant frequency clock signal compared to a constant frequency PWM control signal as shown in FIG. 2 (a). The vertical dotted lines indicate the boundary of a cycle.

To increase the charge in a cycle the controller 16 advances the pulse as shown in FIG. 2 (b). The dotted line indicates the inductor current for the constant frequency control signal in comparison with the solid line that indicates the inductor current for the translated pulse forward in time.

To decrease the charge in a cycle the controller 16 retards the pulse as shown in FIG. 2 (c). The dotted line indicates the inductor current for the constant frequency control signal in comparison with the solid line that indicates the inductor current for the translated pulse backward in time. The area bound by the dotted line and solid line is proportional to the change of charge in a cycle.

If the pulse needs to be translated that far along the time axis that it would enter a next or the previous cycle, the charge can be further increase or decrease by varying the pulse width.

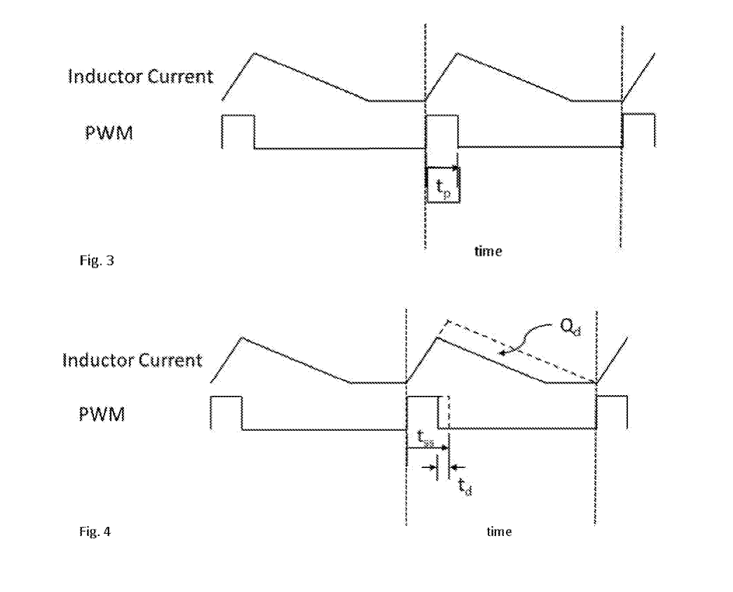

As a predictive method of charge mode control, the controller 16 varies the pulse width of the pulsed control signal such that a resulting charge in a cycle is given by

$$Q = \frac{{V}_{in} - {V}_{out}}{2 L} ( \frac{{V}_{in}}{{V}_{out}} ) {t}_{p}^{2} ,$$

wherein the pulse width tₚ of the PWM signal is shown versus the resulting inductor current in FIG. 3.

FIG. 4 relates to an operation of the power converter as shown in FIG. 1 when a steady state pulse width tₛₛ is determined otherwise. The controller augments the steady state pulse width tₛₛ of the PWM signal by an additional on-time t_{d} as indicated by the dotted line such that an additional charge Q_{d} in a cycle is given by

$$\begin{matrix}{Q}_{d} = \frac{{V}_{in} - {V}_{out}}{2 L} ( \frac{{V}_{in}}{{V}_{out}} ) {t}_{d} [ 2 {t}_{ss} - {t}_{d} ] \\ \approx \frac{{V}_{in} - {V}_{out}}{2 L} ( \frac{{V}_{in}}{{V}_{out}} ) {t}_{d} {t}_{ss} .\end{matrix}$$

The effect on the inductor current is also shown in FIG. 3. It can be observed that the charge increases in the cycle to an extent which is proportional to the area bounded by the dotted line and the solid line of the inductor current.

If the power converter is operated in DCM, then the method reduces time and effort otherwise needed to compensate, as no compensation is necessary. Thus, the method specifically improves the transition from DCM to CCM and thus results in a more robust power converter.

1. A control method for a power converter having a switched power stage configured to generate an output voltage from an input voltage according to a pulsed control signal controlling a switching of the switched power stage, the method comprising:
generating a pulsed control signal for switching the power stage by translating a pulse of a constant frequency PWM signal in phase relative to a corresponding steady state pulse of the constant frequency PWM signal.

2. The method according to claim 1, wherein translating a pulse of the constant frequency PWM signal comprises translating the pulse forward to increase charge in a cycle.

3. The method according to claim 1, wherein translating a pulse of the constant frequency PWM signal comprises translating the pulse backward to decrease charge in a cycle.

4. The method according to claim 1, further comprising:
varying a pulse width of the pulsed control signal so that a square of the pulse width varies in dependence of a voltage error derived from a difference between a reference voltage and the output voltage to further increase or decrease charge in a cycle.

5. The method according to claim 4, wherein:
the pulse width of the pulsed control signal is varied such that a resulting charge Q of a cycle is given by
$$Q = \frac{{V}_{in} - {V}_{out}}{2 L} ( \frac{{V}_{in}}{{V}_{out}} ) {t}_{p}^{2} ,$$
wherein Vᵢₙ is the input voltage, Vₒᵤₜ is the output voltage, L is an inductance of the switchable power stage and tₚ is the pulse width of the pulsed control signal.

6. The method according to claim 4, wherein: the pulse width of the pulse control signal is varied by augmenting a steady state pulse width tₛₛ by an additional on-time t_{d} such that an additional charge Q_{d} of a cycle is given by
$${Q}_{d} = \frac{{V}_{in} - {V}_{out}}{2 L} ( \frac{{V}_{in}}{{V}_{out}} ) {t}_{d} {t}_{ss}$$
when the steady state pulse width tₛₛ is determined otherwise.

7. The method according to claim 4, further comprising:
determining the steady state pulse width tₛₛ prior to generating the pulsed control signal.

8. The method according to claim 7, further comprising:
attempting to detect a steady state or quasi-steady state shift in current; and
adjusting the pulse width to offset a pulse translation resulting from a steady state or quasi-steady state shift when a steady state or quasi-steady state shift has been detected.

9. A power converter comprising: a switched power stage configured to generate an output voltage from an input voltage, and a controller configured to generate a pulsed control signal for switching the power stage by translating a pulse of pulsed constant frequency PWM signal in phase relative to a corresponding steady state pulse of the constant frequency PWM signal.

10. The power converter according to claim 9, wherein the controller is configured to translate the pulse forward to increase charge in a cycle or to translate the pulse backward to decrease charge in a cycle.

11. The power converter according to claim 9, wherein the controller is configured to vary a pulse width of the pulsed control signal so that a square of the pulse width varies in dependence upon a voltage derived from a difference between a reference voltage and the output voltage.

12. The power converter according to claim 10, wherein the controller is further configured to vary the pulse width of the pulse control signal such that a resulting charge Q of a cycle is given by
$$Q = \frac{{V}_{in} - {V}_{out}}{2 L} ( \frac{{V}_{in}}{{V}_{out}} ) {t}_{p}^{2} ,$$
wherein Vᵢₙ is the input voltage, Vₒᵤₜ is the output voltage, L is an inductance of the switchable power stage and tₚ is the pulse width of the pulsed control signal.

13. The power converter according to claim 9, wherein the controller is configured to vary the pulse width of the pulsed control signal by augmenting a steady state pulse width tₛₛ by an additional on-time t_{d} such that an additional charge Q_{d} of a capacitance of the switchable power stage is given by
$${Q}_{d} = \frac{{V}_{in} - {V}_{out}}{2 L} ( \frac{{V}_{in}}{{V}_{out}} ) {t}_{d} {t}_{ss}$$
when the steady state pulse width tₛₛ is determined otherwise.

14. The power converter according to claim 13, further comprising means for determining the steady state pulse width tₛₛ prior to generating the pulse control signal.

15. The power converter according to claim 9, further comprising means to detect a steady state or quasi-steady state shift in current and means to adjust the pulse width to offset a pulse translation resulting from a steady state or quasi-steady state shift when a steady state or quasi-steady state shift has been detected.
